(19) United States
(12) Patent Application Publication
(10) Pub. No.: US 2026/0064450 A1
(43) Pub. Date: Mar. 5, 2026

(54) SYSTEM AND METHOD FOR MANAGING VIRTUAL MACHINES

(71) Applicant: Accenture Global Solutions Limited, Dublin (IE)

(72) Inventors: Priyavanshi Pathania, Chandigarh (IN); Rohit Mehra, New Delhi (IN); Samarth Sikand, Jaipur (IN); Nikhil Bamby, Amritsar (IN); Vibhu Saujanya Sharma, Bangalore (IN); Vikrant Kaulgud, Bangalore (IN); Sanjay Podder, Thane (IN)

(21) Appl. No.: 18/819,982

(22) Filed: Aug. 29, 2024

(51) Int. Cl. G06F 9/455

(52) U.S. Cl. CPC G06F 9/45558; G06F 2009/4557

(57) ABSTRACT

System and method for managing virtual machines (VMs) is disclosed. The method includes, identifying, using a map of VMs, a set of candidate VMs that are predicted to consume less power over time than the first VM for a common workload, removing from consideration any of the candidate VM from the set of candidate VMs that fails to satisfy any predetermined criteria, performing tradeoff analysis on the remaining candidate VMs based on one or more parameters to identify the candidate VMs for redeploying the software operations and ranking the identified candidate VMs based on at least predicted power consumption data for the common workload. The method further includes, selecting, based on the ranking, one of the identified candidate VMs as the second VM, redeploying the software operations from the first VM to the second VM, rerouting data inflow to the first VM to the second VM, and terminating operations of the first VM.

### FIELD OF THE INVENTION

The present disclosure generally relates to the field of virtual machines and more particularly to system and method for managing virtual machines.

### BACKGROUND

In recent years, the rise of applications utilizing technologies such as Artificial Intelligence (AI), Blockchain, and the Metaverse has become increasingly common in daily life. The surge in adoption and usage has significantly increased demand for Virtual Machines (VMs) in the cloud as such applications are generally hosted on the VMs within cloud data centers. The VMs, which run software workloads in cloud data centers, consume substantial energy and generate significant carbon emissions due to the electricity required by the underlying hardware.

Currently, such data centers are estimated to consume 2% of the planet's global power supply, which is estimated to increase to 8% by the year 2030. Yet most VM assignments for software operations do not consider the power requirements of the VMs themselves. As the climate crisis intensifies, it is crucial to seek methods and strategies for managing VM deployments and configurations with a focus on sustainability. Currently, there is a lack of tools and techniques available to assist stakeholders manage VM configurations effectively to lower their overall carbon footprint.

Furthermore, while cloud service providers offer carbon calculators that assess energy usage and carbon emissions, such tools often fall short in providing actionable recommendations for reducing these metrics. A few optimizer tools may offer advice on optimizing Elastic Compute Cloud (EC2) instances, but the focus of such tools is primarily on cost and performance, rather than on reducing carbon emissions.

### SUMMARY

This summary is provided to introduce a selection of concepts in a simple manner that is further described in the detailed description of the disclosure. This summary is not intended to identify key or essential inventive concepts of the subject matter nor is it intended for determining the scope of the disclosure.

A method for redeploying software operations from a first virtual machine (VM) to a second VM is disclosed. The method includes, identifying, using a map of VMs, a set of candidate VMs that are predicted to consume less power over time than the first VM for a common workload, removing from consideration any of the candidate VM from the set of candidate VMs that fails to satisfy any predetermined criteria, performing tradeoff analysis on the remaining candidate VMs based on one or more parameters to identify the candidate VMs for redeploying the software operations, and ranking the identified candidate VMs based on at least predicted power consumption data for the common workload. The method further includes, selecting, based on the ranking, one of the identified candidate VMs as the second VM, redeploying the software operations from the first VM to the second VM, rerouting data inflow to the first VM to the second VM, and terminating operations of the first VM.

Further disclosed is a method for generating the map of VMs. The method includes, selecting a pair of VMs from the plurality of VMs, the pair of VMs including a higher power consuming VM for a first workload and a lower power consuming VM for a second workload, receiving performance data and power consumption data of the higher power consuming VM, predicting performance data for the lower power consuming VM of the pair of VMs under the first workload, predicting power consumption data for the lower power consuming VM based on the predicted performance data and using a trained machine learning model, determining whether the predicted power consumption data for the lower power consuming VM remains lower than the power consumption data of the higher power consuming VM, and linking in the map of VMs, in response to a positive result of the determining, a candidate migration from the higher power consuming VM to the lower power consuming VM.

Further disclosed is a system for redeploying software operations from a first virtual machine (VM) to a second VM. The system includes a processor and a memory storing instructions programmed to cooperate with the processor to perform operations. The operations including, identifying, using a map of VMs, a set of candidate VMs that are predicted to consume less power over time than the first VM for a common workload, removing from consideration any of the candidate VM from the set of candidate VMs that fails to satisfy any predetermined criteria, performing tradeoff analysis on the remaining candidate VMs based on one or more parameters to identify the candidate VMs for redeploying the software operations, and ranking the identified candidate VMs based on at least predicted power consumption data for the common workload. The operations further including, selecting, based on the ranking, one of the identified candidate VMs as the second VM, redeploying the software operations from the first VM to the second VM, rerouting data inflow to the first VM to the second VM, and terminating operations of the first VM.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts a block diagram of a system for redeploying software operations from a first virtual machine (VM) to a second VM, in accordance with an embodiment of the present disclosure;

FIG. 2 depicts a detailed architecture illustrating a method for redeploying the software operations from the first VM to the second VM, in accordance with an embodiment of the present disclosure;

FIG. 3 depicts a detailed process flow of creating the map of VMs, in accordance with an embodiment of the present disclosure;

FIG. 4 depicts a flow chart illustrating a method for redeploying software operations from a first virtual machine (VM) to a second VM, in accordance with an embodiment of the present disclosure; and

FIG. 5 illustrates a schematic diagram of an exemplary generic classical processor system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

As described, surge in adoption and usage of AI, Blockchain, and the Metaverse and other applications has significantly increased demand for VMs in the cloud as such applications are generally hosted on the VMs within cloud data centers.

A technical problem with traditional VM deployment is the corresponding high demand for electricity needed to support the underlying hardware infrastructure. Currently, such data centers are estimated to consume 2% of the planet's global power supply, which is estimated to increase to 8% by the year 2030. Yet most VM assignments for software operations do not consider the power requirements of the VMs themselves. There is thus a specific technical problem in excessive power consumption of the VMs in the data centers, and corresponding need to reduce the power consumption.

Embodiments of the present disclosure disclose a system and a method for redeploying software operations from a first Virtual Machine (VM) to a second VM which utilizes less power than the power utilized by the first VM. The system and method disclosed in the present disclosure leverages various heterogenous data from the engineering data and carbon footprint provided by the Cloud Service Providers (CSPs) to recommend and migrate higher power utilizing VMs (carbon-inefficient VMs) to lower power utilizing VMs (carbon-efficient alternative VM) deployment strategies. For example, migrating software workload from a first VM to a second VM, on the same CSP or across multiple CSPs. The system and method further ensure optimal compatibility and migration feasibility of the recommendations and ranks VMs for adoption based on a trade-off analysis with key parameters including but not limited to cost, availability, and latency. The system and method automate process identification, recommendation and migration, and offer significant carbon reductions while maintaining applications usability, compatibility, and business Service-level Agreements (SLAs).

The term ‘workload and the like refers to a specific software operation allocated to a VM to execute. A “common” workload in the context of multiple VMs refers to a software operation that allocated to multiple VMs, and for which the allocation may be actual or hypothetical to estimate VM performance. Common workloads may be used for multiple VMs to establish baseline power consumption for different VMs under comparable conditions.

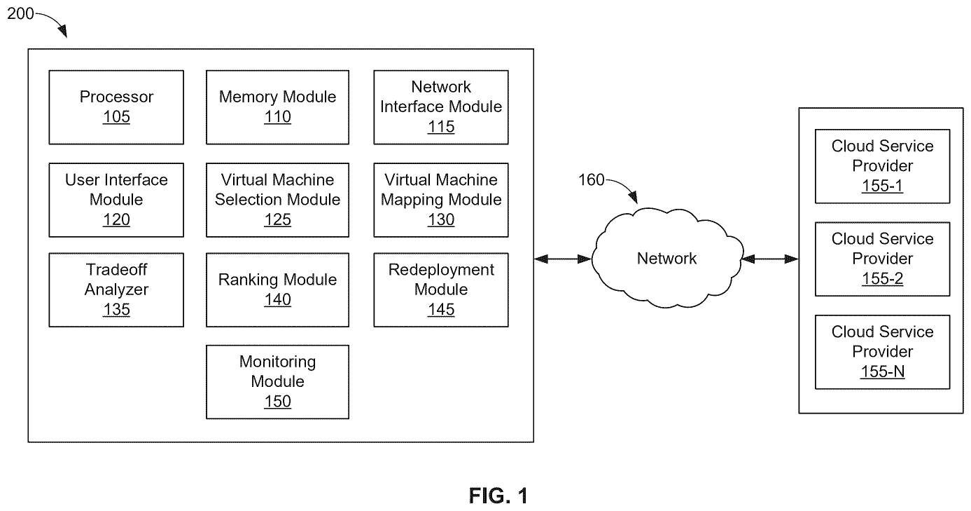

FIG. 1 depicts a block diagram of a system for redeploying software operations from a first virtual machine (VM) to a second VM, in accordance with an embodiment of the present disclosure. As shown, the system 100 includes a processor 105, a memory module 110, a network interface module 115, a user interface module 120, a virtual machine (VM) selection module 125, a VM mapping module 130, a tradeoff analyzer 135, a ranking module 140, a deployment module 145 and a monitoring module 150. It is to be noted that the system 100 may include, for example, a mainframe computer, a computer server or a network of computers with big data processing capabilities. Accordingly, the system 100 includes one or more processors, interfaces and storage devices communicatively interconnected to one another through one or more communication means. The storage associated with the system 100, the memory module 110, may include volatile and non-volatile memory devices for storing information and instructions to be executed by the one or more processors, for example processor 105, and for storing temporary variables or other intermediate information during processing. Further, the network interface module 115 enables communication between the system 100 and systems associated cloud service providers (CSPs) 155-1 to 155-N through a communication network 160. The communication network may include a wired or a wireless or a combination of wired and wireless communications links. Furthermore, the user interface module 120 may include input and output devices that enables a user to interact with the system 100 for redeploying software operations from a first virtual machine (VM) to a second VM, for example. Alternatively, a user, for example a software administer, may use an external computing device (not depicted in FIG. 1) to interact with the system 100 through the communication network 160. It is to be noted that the one or more modules such as the VM selection module 125, the VM mapping module 130, the tradeoff analyzer 135, the ranking module 140, the deployment module 145 and monitoring module 150 may be implemented using the one or more processors, for example the processor 105.

Software operations for an application are usually deployed across several virtual machines (VMs). Such VMs may be provided by different Cloud Service Providers (CSPs), and each CSP might use different types of underlying hardware configurations. Such an approach allows for improved scalability, reliability, load balancing, and manageability of the application and operations. However, a software operation deployed on a VM may also be deployed on another VM by the same CSP or from a different CSP. In one embodiment of the present disclosure, the system 100 identifies a set of VMs that consume less power over a time than a VM on which a software operation is deployed, selects one VM among the set of VMs based on one or more conditions, and redeploys the software operation to the selected VM which consumes less power than the original VM on which the operation was deployed. That is, the system 100 is configured to redeploy software operations from a first VM to a second VM that consumes less power than the first VM. The manner in which the system 100 redeploys the software operations is described in more detail below.

Initially, the VM selection module 125 identifies a set of candidate VMs that are predicted to consume less power over time than the first VM for a common workload. In one embodiment, the VM selection module 125 uses a map of VMs for identifying the set of candidate VMs that are predicted to consume less power over time than the first VM for the common workload. The map of VM is a pre-created map by leveraging continuous data of a plurality of VMs under consideration, and the map is also updated in real-time or based on any changes in the VM deployment or periodically. In other words, the map of VMs is a collection of bipartite graphs (a.k. a. maps) for each VM under consideration. The bipartite graphs represent a mapping between a vertex V₁ in a set S₁ to multiple vertices V₂, V₃, to Vₙ in set a S₂, where the vertices refer to specific types of VMs and the set S₁ includes the VMs in use and the set S₂ includes the energy efficient VMs. Each edge in the graph represents the potential to replace a specific VM type (V₁) with another VM type (V₂), which can potentially lead to less power consumption, leading to 0% to 100% reduction in carbon emissions. Edges are created only between two vertices where a carbon reduction potential is observed. For example, the map of VM may include mapping or a link between VM_1 and VM_A, a link between VM_1 and VM_B, a link between VM_1 and VM_C, a link between VM_1 and VM_X, and a link between VM_1 and VM_Y, wherein the VM_A, VM_B, VM_C, VM_X and VM_Y are predicted to consume less power over time than the VM_1 for a common workload, thus indicating potential redeployment or migration. Hence, the map of VMs includes a list of a plurality of VMs and mappings between the VMs based on predicted power consumption data for a common workload. The manner in which the map of VM is created by the virtual machine mapping module 130 using a trained machine learning model (also referred to as power consumption prediction model or carbon predict model) and the map is updated in explained in detail further below in the present disclosure.

As described, the VM selection module 125 uses the map of VMs for identifying the set of candidate VMs that are predicted to consume less power over time than the first VM for the common workload. Hence, the set of candidate VMs selected may be VM_A, VM_B, VM_C, VM_X and VM_Y, for the first VM, that is, VM_1.

Upon selecting the set of candidate VMs, VM selection module 125 removes from consideration any of the candidate VM from the set of candidate VMs that fails to satisfy any predetermined criteria. The predetermined criteria correspond to conflicts with redeployment of the software operations to any VM among the plurality of VM. Example types of predetermined criteria may include but not limited to VM type adherence criteria, region adherence criteria, idle capacity adherence criteria, vendor adherence criteria and business SLA adherence criteria. Such predetermined criteria may be defined by the administrator of the software or predefined in technical documents of the VMs, software development map, VM performance data, and business SLAs. Considering the region adherence criteria, the predetermined criteria may define regions allowed for migrating the first VM, the VM_1, and if VM_X is outside the allowable region, then the VM_X is removed from consideration. That is, the VM_X is not considered for migration or redeploying the software operation from VM_1 to VM_X even if the VM_X consumes less power than the VM_1 for the same workload. In another example, if any of the selected candidate VMs fails to meet the business SLA, then that VM is not considered for migration.

Then, the tradeoff analyzer 135 performs tradeoff analyses on the remaining candidate VMs based on one or more parameters to identify the candidate VMs for redeploying the software operations. The one or more parameters as described herein includes but not limited to cost, latency, availability, and data sovereignty, wherein values for the one or more parameters is derived from technical document of the VMs, the software deployment map, etc. In one embodiment, the tradeoff analyzer 135 performs tradeoff analyses by comparing the values of the parameters. For example, if the processing time of the first VM, VM_1, is less than the processing time of one of the remaining candidate VMs, for example VM_Y, then the VM_Y is removed from consideration for migration. In the present example, the tradeoff analyzer 135 identifies the candidates VMs, the VM_A, the VM_B, and the VM_C, as VMs for redeploying the software operations. It is to be noted that tradeoff analyzer 135 performs tradeoff analyses on the remaining candidate VMs using techniques including but not limited to cost analysis, Multi-Criteria Decision Analysis (MCDA), Pareto Analysis, and decision trees.

Then, the ranking module 140 assigns a rank to each of the identified candidate VMs based on at least predicted power consumption data for the common workload. The predicted power consumption may be the amount of power a VM consumes over a time or power consumption relative to the performance provided by the VM. The power consumption relative to the performance provided by the VM may be calculated as energy per unit of performance, for example, watts per transaction or watts per compute unit, and then the power consumption over a time is calculated. Considering the example, the ranking module 140 may assign a rank “1” for the VM_A if the VM_A is predicted to consume less power over the time for the common workload in comparison with the other VMs, that is, VM_B which is predicted to consume more power than VM_A, and VM_C which is predicted to consume more power than the VM_A and the VM_B. In one embodiment of the present disclosure, the ranking is performed based on the one or more parameters, muti-objective ranking. For example, if the VM_B is predicted to consume less power over the time than the VM_C, however, the VM_C is cost effective than the VM_B, then higher rank is assigned to VM_C. It is to be noted that the ranking module 140 may use any other ranking methods such as but not limited to weighted scoring, for example.

Upon ranking, the deployment module 145 selects, based on the ranking, one of the identified candidate VMs as the second VM, redeploys the software operations from the first VM to the second VM, and reroutes data inflow to the first VM to the second VM, that is, the data coming into the first VM is routed to second VM. Further, the deployment module 145 terminates the operations of the first VM.

In one embodiment of the present disclosure, to select the one of the identified candidate VMs as the second VM, the deployment module 145 simulates the common workload to test the identified VMs in a hierarchical order of the ranks and terminates the simulation, in response to a positive result of the test, and select the identified VM as the second VM. For example, the deployment module 145 selects the highest ranked VM, that is VM_A, and simulates the common workload to test the VM_A. That is, the deployment module 145 executes the test suite of the workload to verify if the test pass rate matches that of the existing VM, the first VM (VM_1). Upon successful verification, the first VM is decommissioned, and all traffic are rerouted to the second VM. This process may be facilitated using templatized infrastructure-as-code files. If a failure occurs during validation, the next recommendation in the list, the second highest ranked VM (VM_B) is selected for simulation. This iterative process is continued until a recommendation is successfully implemented, that is, until a VM is selected as the second VM from the ranked list of identified candidate VMs.

Further, in one embodiment of the present disclosure, the monitoring module 150 is configured to continuously monitor the second VM to assess the power consumption over the time, hence, to assess the carbon impact. The process involves verifying whether the predicted power consumption over the time aligns with the actual power consumption over the time after the migration or deployment. If discrepancies are identified, then the machine learning model (the power consumption prediction model) is re-trained to enhance accuracy, thereby establishing a complete feedback loop. Furthermore, one embodiment, the monitoring module 150 is configured to detect environmental changes that necessitate redeployment of the software operations. For example, if a CSP updates the underlying infrastructure of a VM by moving the VM from a Server_1 to a Server_2, which have slightly different configurations (such as Central Processing Unit (CPU) model variations), hashing algorithms (SHA 256, MD5, etc.) are utilized to identify such changes. Once such changes are detected, the redeployment process is restarted to select a new VM (a third VM for example) based on the revised specifications.

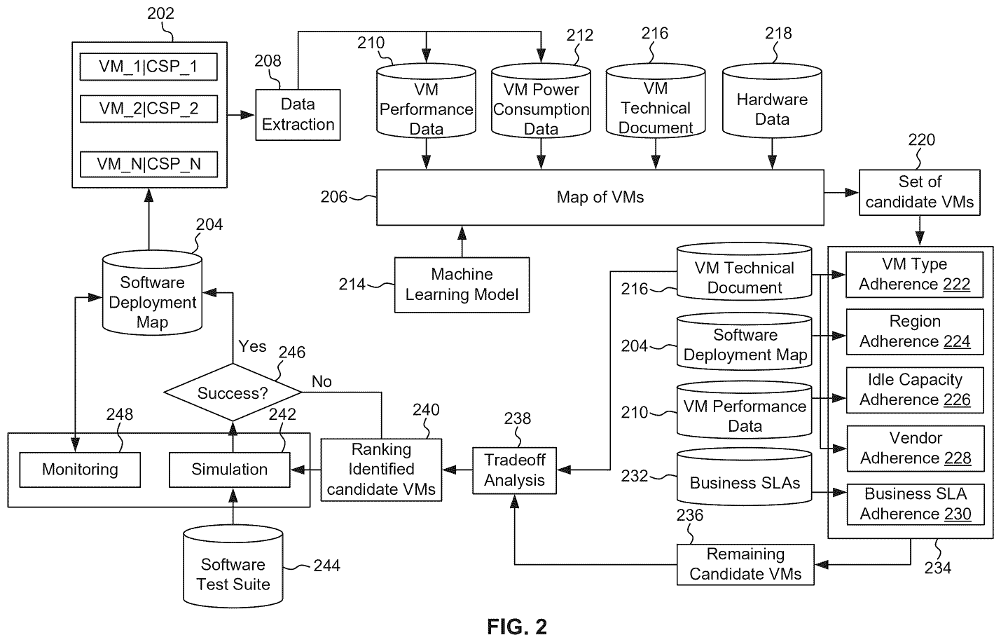

FIG. 2 depicts a detailed architecture illustrating a method for redeploying the software operations from the first VM to the second VM, in accordance with an embodiment of the present disclosure. As described, the software operations for an application are usually deployed across several virtual machines (VMs). Such VMs may be provided by different Cloud Service Providers (CSPs), and each CSP might use different types of underlying hardware configurations. As shown in block 202, one software operation may be deployed on VM_1 of CSP_1, a second software operation may be deployed on VM_2 of CSP_2 and similarly, an n^{th} software operation may be deployed on VM_N of CSP_N. Typically, the deployment of multiple software operations managed by a software deployment map 204 as shown. The software deployment map 204 illustrates the architecture, relationships, and dependencies among different software operations and their deployment locations.

In one embodiment, the system 100 uses a map of VMs for identifying the set of candidate VMs that are predicted to consume less power over time than the first VM for the common workload. Referring to FIG. 1 and FIG. 2, the map of VMs 206 is a pre-created map by the VM mapping module 130 which extracts data 208 of the plurality of VMs under consideration, for example VM_1 to VM_N. In another embodiment, the map of VMs 206 is created in real-time using the extracted data 208 of the plurality of VMs under consideration. The map is also updated in real-time or based on any changes in the VM deployment or periodically.

In one embodiment of the present disclosure, to create the map of VMs 206, initially a pair of VMs from the plurality of VMs is selected, the pair of VMs including a higher power consuming VM for a first workload and a lower power consuming VM for a second workload. Then the performance data 210 and power consumption data 212 of the higher power consuming VM is received. Then performance data for the lower power consuming VM is predicted under the first workload. Further, power consumption data for the lower power consuming VM is predicted based on the predicted performance data and using the trained machine learning model 214. Then the predicted power consumption data for the lower power consuming VM is compared with the power consumption data of the higher power consuming VM, and a link (edge) is connected between the higher power consuming VM and the lower power consuming VM in the map, in response to a positive result of the determining. The link indicates the possibility of candidate migration from the higher power consuming VM to the lower power consuming VM and also indicates the potential power savings over a time.

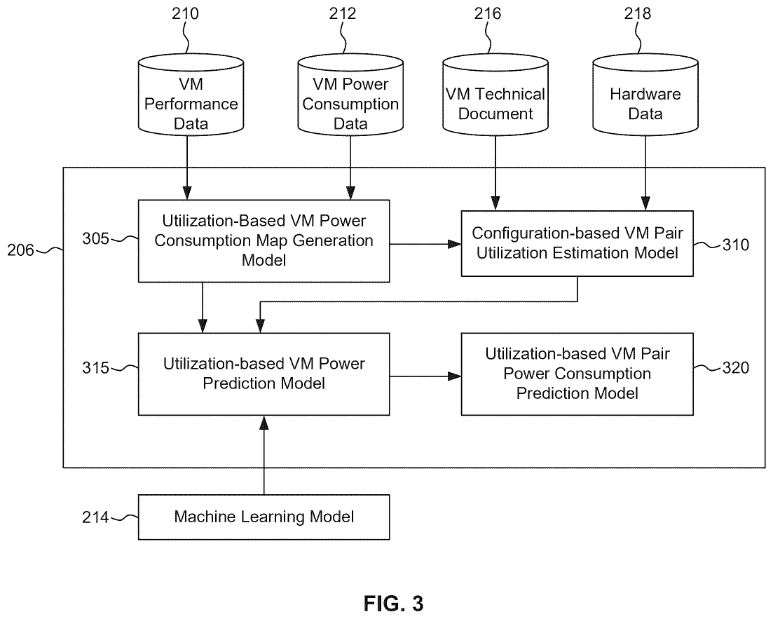

FIG. 3 depicts a detailed process flow of creating the map of VMs, in accordance with an embodiment of the present disclosure. To create the map of VMs 206, initially the pair of VMs from the plurality of VMs is selected, the pair including the higher power consuming VM for a first workload and the lower power consuming VM for the second workload. The pair of VMs may be selected by analyzing the technical document 216 of the plurality of VMs and the hardware data 218. Alternatively, the pair of VMs may be selected based on the historical power consumption data over a time, for example.

Then the performance data 210 and power consumption data 212 of the higher power consuming VM is received using Application Programming Interface (APIs) of the CSPs and tools of the CSPs. The performance data 210 may include but limited to CPU utilization data, Graphics Processing Unit (GPU) utilization data, and memory consumption data. The power consumption data 212 include information on power consumed by the VM. For example, the power consumption data may indicate the power consumption by the VM when the VM is utilizing 10% of CPU, 20% of GPU and 50% memory, for example. The power consumption data may be determined as power consumption over a time. The power consumption data denotes the carbon produced by a specific VM under specific utilization levels. Hence, the performance data 210 and the power consumption data 212 needs to be continuously extracted since the VM performance and carbon metrics vary throughout, and the variations can be very large under certain special circumstances, for example changes in the VM's underlying server. Referring to FIG. 3, in on embodiment, a utilization-based VM power consumption map generation model creates a map or table that indicates the power consumption data at multiple performance level of the VM. For example, the map may indicate that the VM_1 is consuming ‘X’ amount of power at 25% of CPU utilization, the VM_2 is consuming ‘Y’ amount of power at 22% of CPU utilization, etc.

Considering the pair of VMs (VM_1 and VM_2), the VMs may be running a different workload. Hence, to determine if the migration from VM_1 to VM_2 is possible or not, the power consumption by the VM_2 needs to be estimated when the VM_2 will be running the same workload as VM_1. To estimate the power consumption by the VM_2, initially a configuration-based VM pair utilization estimation model 310 predicts performance data for the VM_2 of the pair under the first workload, that the workload running on VM_1. In one embodiment, configuration-based VM pair utilization estimation model 310 leverage analytical functions for multi-criteria extrapolation to predict the utilization values when migrating first workload from VM_1 to VM_2. For example, to estimate GPU utilization, the model uses the GPU FLOPS of the hardware, from the VM technical document 216 and hardware data 218, to extrapolate (scale up or down) the utilization values based on the target hardware GPU.

Then, using the predicted performance data and using the trained machine learning model 214, the utilization-based VM power prediction model 315 predicts the power consumption data for the VM_2. The power consumption of a VM typically exhibit non-linear behavior in relation to utilization values. Hence, to accurately predict power consumption of the any VM, precise machine models is developed for each VM. In the present example, to accurately predict power consumption of the VM_2, precise machine learning model is developed for the VM_2. During the training process, regression-based techniques are employed to construct well-fitted custom regression models using curated data points. Custom models (such as XGBoost, LightGBM, etc.) may utilize attributes like utilization values as independent variables and power consumption as the dependent variable. To mitigate VM migrations based on inaccurate estimations due to model cold-start, the collected data points should cover utilization ranges in increments of 10% (e.g., one data point between 0-10%, another between 10-20%, etc.). Increasing the number of data points enhances the accuracy of carbon estimation, thus, the models should be continually retrained with newly captured data.

Upon predicting the power consumption data for the VM_2, a utilization-based VM pair power consumption prediction Model 320 determines if the migration is possible or not. For example, the utilization-based VM pair power consumption prediction Model 320 compares the predicted power consumption data of the VM_2 with the power consumption data of the VM_1, and links (forms an edge) the VM_1 and VM_2, in response to a positive result of the comparison. The link indicates the possibility of candidate migration from the VM_1 to the lower power consuming VM_2 and also indicates the potential reduction in power consumption over a time. Since the power consumption is directly proportional to the carbon emission, utilization-based VM pair power consumption prediction Model 320 calculates the projected carbon emissions on the target VM, that is VM_2 for example. The process is performed for each of the plurality of VMs (VM_1 to VM_N) to create the map of VMs. As described, using the predicted power consumption, the mode of VMs is updated to incorporate estimated utilization values and the power consumption (carbon emissions). Any edges indicating no carbon reduction are removed, indicating infeasibility of those migrations. The updated map of VMs presents viable VM migration options that could potentially reduce carbon emissions while maintaining workload deployment across both the first VM and the second VM.

Referring back to FIG. 2, the map of VMs 206 is used to identify the set of candidate VMs that are predicted to consume less power over time than the first VM for the common workload, the first VM is the VM on which the software operation is deployed. As described, the VM selection module 125 uses the map of VMs 206 for identifying the set of candidate VMs that are predicted to consume less power over time than the first VM for the common workload. Considering the example of the FIG. 1, the set of candidate VMs selected 220 may be VM_A, VM_B, VM_C, VM_X and VM_Y, for the first VM, that is, VM_1. In this phase, the candidate VMs are selected solely on power consumption reduction potential without considering the specific context of the software or business. As a result, some migrations identified in this phase may not be viable depending on the unique circumstances of the software or business. In one embodiment, the set of candidate VMs are further refined and contextualized, with certain edges removed, by considering specific important contextual parameters.

To filter the selected set of candidate VMs 220, in phase 234, the VM selection module 125 removes from consideration any of the candidate VM from the set of candidate VMs 220 that fails to satisfy any of the predetermined criteria. The predetermined criteria correspond to conflicts with redeployment of the software operations to any VM among the plurality of VM. Example types of predetermined criteria may include but not limited to VM type adherence criteria 222 derived from technical document 216 of the VMs, region adherence criteria 224 derived from the software deployment map 204, idle capacity adherence criteria 226 derived from the performance data 210 of the VMs, vendor adherence criteria 228 derived from the technical document of the 216 VMs, and business SLA adherence criteria 230 derived from business SLAs 232. Such predetermined criteria may be defined by the administrator or obtained from the sources of the CSPs. Considering the region adherence criteria, the predetermined criteria may define regions allowed for migrating the first VM, the VM_1, and if VM_X is outside the allowable region, then the VM_X is removed from consideration. That is, the VM_X is not considered for migration or redeploying the software operation from VM_1 to VM_X even if the VM_X consumes less power than the VM_1 for the same workload. In another example, if any of the selected candidate VMs fails to meet the business SLA, then that VM is not considered for migration.

As described, in the above phase 234, multiple clusters, each reflecting specific contextual parameters, may be created by leveraging the technical specifications of the VMs. For example, vendors of the underlying hardware components such as GPUs and CPUs may be used to form vendor adherence clusters. Clustering techniques like KNN, DBScan, and Hierarchical clustering may be leveraged for categorizing VMs into semantically similar and heterogeneous clusters. Key attributes for clustering include the vendor of the underlying hardware, available regions for a specific type of VM, and the VM type (e.g., memory-focused, compute-focused). Using the clusters, the VM selection module 125 removes all the edges that link VMs from different clusters. This refinement ensures adherence to specific parameters, thereby enhancing the relevance and applicability of the selected as of candidate VMs based on the contextual attributes of VMs.

In the example, the idle capacity adherence denotes surplus compute, memory, or storage available to handle peak traffic or load. To determine if the target VM (for example the second VM) can adequately handle peak traffic, historical performance data 210 of the VM can be analyzed to calculate the VM's mean and peak load percentages (temporal analysis). Utilizing the Configuration-based VM Pair Utilization Estimation Model 310, estimates for both mean and peak load percentages can be generated for the target VM_2. Finally, the VM of which the peak load percentage exceeds a predefined SME defined threshold (e.g., 90%) can be excluded.

Business SLAs often define critical constraints that must be observed when making architectural and deployment decisions. For example, SLAs may dictate the use of dedicated VMs with no spot instances allowed. In one embodiment, LLM-based expert role-playing AI agents are employed to extract specific SLAs from SLA documents and transformed into a set of adherence rules. Such rules may then be applied to the set of selected VMs 220 to detect any instances of non-compliance, using rule-based engines. If a rule is found to be violated, the VM is excluded from the VM migration considerations.

As described, the output of phase 234 includes filtered candidates VMs, referred to as remaining candidate VMs 236. Then, the tradeoff analyzer 135 performs tradeoff analyses 238 on the remaining candidate VMs based on the one or more parameters to identify the candidate VMs for redeploying the software operations. The one or more parameters as described herein includes but not limited to cost, latency, availability, and data sovereignty, wherein values for the one or more parameters is be derived from technical document 216 of the VMs, the software deployment map 204, etc. In one embodiment, the tradeoff analyzer 135 performs tradeoff analyses by comparing the values of the parameters. For example, if the processing time of the first VM, VM_1, is less than the processing time of one of the remaining candidate VMs, for example VM_Y, then the VM_Y is removed from consideration for migration. In the present example, the tradeoff analyzer 135 identifies the candidates VMs, the VM_A, the VM_B, and the VM_C, as VMs for redeploying the software operations. It is to be noted that tradeoff analyzer 135 performs tradeoff analyses 238 on the remaining candidate VMs 236 using techniques including but not limited to cost analysis, Multi-Criteria Decision Analysis (MCDA), Pareto Analysis, and decision trees.

In one embodiment, an ε-constrained single-objective optimization solver can be leveraged to filter remaining candidate VMs 236 that result in unacceptable trade-offs. For example, the VM that increase cost by 50% while reducing carbon by only 5% is excluded. With power consumption reduction (carbon reduction) as the primary objective, the problem statement will be, ‘minimize the carbon footprint (CF) while keeping latency (L) and cost (C) below specified thresholds (ε_L and ε_C). The thresholds may be defined by project or sustainability subject matter experts (SMEs). For example, the cost could be maintained at the current level or allowed to increase by a maximum of 10%. This approach ensures that any remaining candidate VMs 236 not adhering to the specified thresholds are not considered for migration. The output of tradeoff analysis 238 are the candidate VMs identified for redeploying the software operations.

Then the identified candidate VMs are ranked using the ranking module 140 as shown in block 240. The ranking process 240 assigns a rank to each of the identified candidate VMs based on at least predicted power consumption data for the common workload. Considering the example, the ranking module 140 may assign a rank “1” for the VM_A if the VM_A is predicted to consume less power over the time for the common workload in comparison with the other VMs, that is, VM_B which is predicted to consume more power than VM_A, and VM_C which is predicted to consume more power than the VM_A and the VM_B. In one embodiment of the present disclosure, the ranking is performed based on the one or more parameters, muti-objective ranking. For example, if the VM_B is predicted to consume less power over the time than the VM_C, however, the VM_C is cost effective than the VM_B, then higher rank is assigned to VM_C. It is to be noted that the ranking module 140 may use any other ranking methods such as but not limited to weighted scoring, for example.

In one embodiment, for ranking the identified candidate VMs, that is to create a ranked list of migrations for a specific VM (first VM), multi-objective decision-making tools such as Technique for Order of Preference by Similarity to Ideal Solution (TOPSIS) or analytic hierarchy process (AHP) are be utilized. The project or sustainability SME may guide the prioritization and weightage of the optimization factors. For example, equal weight to cost and latency may be assigned, or prioritize cost over latency. The result is sorted and ranked list of the identified candidate VMs is generated, optimizing for maximum carbon emission savings while ensuring acceptable trade-offs for other key factors. The prioritized list is referred as the ranked VM candidate recommendations.

Upon ranking, the deployment module 145 selects, based on the ranking, one of the identified candidate VMs as the second VM, redeploys the software operations from the first VM to the second VM, and reroutes data inflow to the first VM to the second VM, that is, the data coming into the first VM is routed to second VM. Further, the deployment module 145 terminates the operations of the first VM.

In one embodiment of the present disclosure, to select the one of the identified candidate VMs as the second VM, the deployment module 145 performs simulation 242 using the common workload to test the identified VMs in a hierarchical order of the ranks and terminates the simulation 242, in response to a positive result of the test, and select the identified VM as the second VM. For example, the deployment module 145 selects the highest ranked VM, that is VM_A, and simulates the common workload to test the VM_A. That is, the deployment module 145 executes the software test suite 244 of the workload to verify if the test pass rate matches that of the existing VM, the first VM (VM_1) as shown in block 246. Upon successful verification, the first VM is decommissioned, and all traffic are rerouted to the second VM. This process may be facilitated using templatized infrastructure-as-code files. It is to be noted that the software deployment map 204 is used with the migrated VM for further reference and analysis. If a failure occurs during validation, the next recommendation in the list, the second highest ranked VM (VM_B) is selected for simulation. This iterative process is continued until a recommendation is successfully implemented, that is, until a VM is selected as the second VM from the ranked list of identified candidate VMs.

Further, in one embodiment of the present disclosure, the monitoring module 150 continuously monitors the second VM to assess the power consumption over the time, hence, to assess the carbon impact as shown in block 248. The process involves verifying whether the predicted power consumption over the time aligns with the actual power consumption over the time after the migration or deployment. If discrepancies are identified, then the machine learning model (the power consumption prediction model) is re-trained to enhance accuracy, thereby establishing a complete feedback loop. Furthermore, one embodiment, the monitoring module 150 is configured to detect environmental changes that necessitate redeployment of the software operations. For example, if a CSP updates the underlying infrastructure of a VM by moving the VM from a Server_1 to a Server_2, which have slightly different configurations (such as CPU model variations), hashing algorithms (SHA 256, MD5, etc.) are utilized to identify such changes. Once such changes are detected, the redeployment process is restarted to select a new VM based on the revised specifications. Hence, system and method disclosed in the present disclosure monitors for changes in hardware configurations or power consumption of the second VM to which the software operations are migrated, and if the changes are identifies, the system redeploys the software operations from the second VM to a third VM by identifying the third VM through the method disclosed. Further, the system 100 updates the map of VMs.

As described, the system and method disclosed in the present disclosure leverages performance and power consumption data from the cloud to understand the power consumption (carbon emission) of various VMs and develop a map of VM which is used to migrate existing VM deployments to power efficient (carbon-efficient) VM deployments. In addition, the proposed system and method evaluates whether the software workload can be migrated to the recommended VM, based on the workload specifications and the vendor configuration for the recommended VM. Adherence to such considerations ensures that the application's context is preserved while maintaining various business SLAs. Further, the system and method take into account of client context to determine an optimal carbon-aware deployment strategy that balances the parameters such as cost, availability, latency, and data residency as a multi-objective optimization.

Furthermore, the system automatically simulates the ranked VMs, applies the selected VM, and continuously monitored for exceptions, which may potentially lead to the re-triggering of the entire process under certain adverse circumstances.

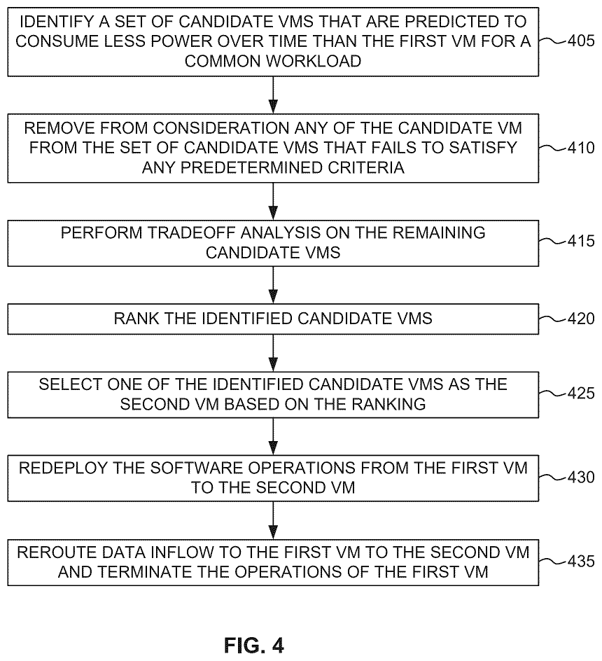

FIG. 4 depicts a flow chart illustrating a method for redeploying software operations from a first virtual machine (VM) to a second VM, in accordance with an embodiment of the present disclosure. To redeploy software operations from a first virtual machine (VM) to a second VM, the system 100 identifies a set of candidate VMs that are predicted to consume less power over time than the first VM for a common workload as shown at step 405. In one embodiment, the set of candidate VMs are identified using a map of VMs.

At step 410, the system 100 removes from consideration any of the candidate VM from the set of candidate VMs that fails to satisfy any predetermined criteria. The predetermined criteria correspond to conflicts with redeployment of the software operations to any VM among the plurality of VM. Example types of predetermined criteria may include but not limited to VM type adherence criteria, region adherence criteria, idle capacity adherence criteria, vendor adherence criteria and business SLA adherence criteria.

At step 415, the system 100 performs tradeoff analysis on the remaining candidate VMs based on one or more parameters to identify the candidate VMs for redeploying the software operations. The one or more parameters as described herein includes but not limited to cost, latency, availability, and data sovereignty, wherein values for the one or more parameters is derived from technical document of the VMs, the software deployment map, etc. In one embodiment, an ε-constrained single-objective optimization solver is leveraged to performs the tradeoff analysis.

At step 420, the system 100 ranks the identified candidate VMs based on at least predicted power consumption data for the common workload. In one embodiment, for ranking the identified candidate VMs, that is to create a ranked list of migrations for a specific VM (first VM), multi-objective decision-making tools such as Technique for Order of Preference by Similarity to Ideal Solution (TOPSIS) or analytic hierarchy process (AHP) are be utilized.

At step 425, the system 100 selects one of the identified candidate VMs as the second VM based on the ranking. In one embodiment of the present disclosure, to select the one of the identified candidate VMs as the second VM, the deployment module 145 performs simulation 242 using the common workload to test the identified VMs in a hierarchical order of the ranks and terminates the simulation 242, in response to a positive result of the test, and select the identified VM as the second VM.

At step 430, the system 100 redeploys the software operations from the first VM to the second VM and updates the software deployment map 204. At step 435, the system 100 reroutes data inflow to the first VM to the second VM and terminates the operations of the first VM.

The above methodology provides a technical solution to the growing power demands of VMs running on the cloud. For any deployment of software operations on a collection of VMs, the methodology identifies replacement VMs on a VM-by-VM basis that can perform the software operations while consuming less power. The mapping of known VMs to lower power candidate VMs based on common workload conditions and the corresponding ranking allows for the optimal selection of replacement VMs to provide the best power savings on a VM-by-VM basis. Redeploying the software operations to the lower power VMs in combination with terminating the replaced original VMs reduces the overall power demand for running the software operations. The disclosed methodology meets the specific need to reduce the power consumption of the VMs in the data centers.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a classical processor system.

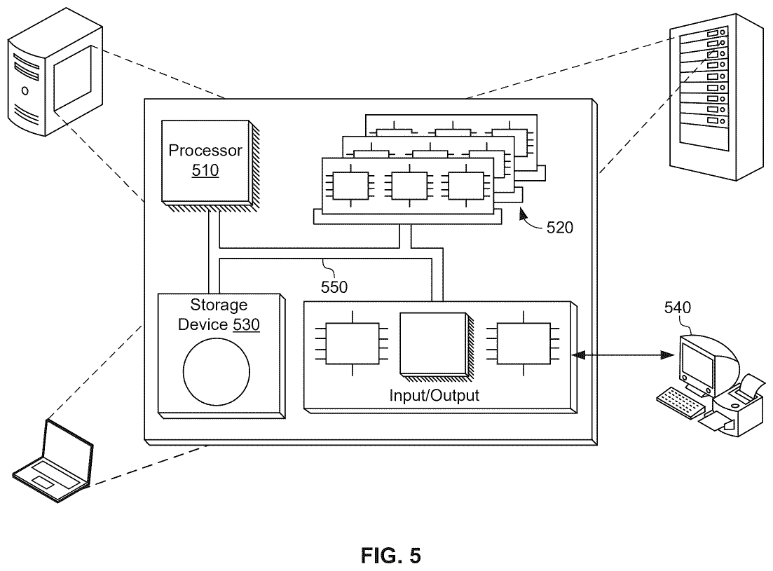

FIG. 5 illustrates a schematic diagram of an exemplary generic classical processor system. The system 500 can be used for the software operations redeployment operations described in this specification according to some implementations. The system 500 is intended to represent various forms of digital computers, workstations, servers, blade servers, mainframes, and other appropriate computers. The components shown, their connections and relationships, and their functions, are exemplary only, and do not limit implementations of the inventions described and/or claimed in this document. The system 500 includes a processor 510, a memory 520, a storage device 530, and an input/output device 540. Each of the components 510, 520, 530, and 520 are interconnected using a system bus 550. The processor 510 may be enabled for processing instructions for execution within the system 500. In one implementation, the processor 510 is a single-threaded processor. In another implementation, the processor 510 is a multi-threaded processor. The processor 510 may be enabled for processing instructions stored in the memory 520 or on the storage device 530 to display graphical information for a user interface on the input/output device 540. In one implementation, the memory 520 is a computer-readable medium. In one implementation, the memory 520 is a volatile memory unit. In another implementation, the memory 520 is a non-volatile memory unit. The storage device 530 may be enabled for providing mass storage for the system 500. In one implementation, the storage device 530 is a computer-readable medium. In various different implementations, the storage device 530 may be a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for redeploying software operations from a first virtual machine (VM) to a second VM, the method comprising:
identifying, using a map of VMs, a set of candidate VMs that are predicted to consume less power over time than the first VM for a common workload;
removing from consideration any of the candidate VM from the set of candidate VMs that fails to satisfy any predetermined criteria;
performing tradeoff analysis on the remaining candidate VMs based on one or more parameters to identify the candidate VMs for redeploying the software operations;
ranking the identified candidate VMs based on at least predicted power consumption data for the common workload;
selecting, based on the ranking, one of the identified candidate VMs as the second VM;
redeploying the software operations from the first VM to the second VM;
rerouting data inflow to the first VM to the second VM; and
terminating operations of the first VM.

2. The method of claim 1, wherein the map of VMs comprises a list of a plurality of VMs and mappings between the VMs based on predicted power consumption data for the common workload.

3. The method of claim 2, wherein generating the map of VMs comprising:
selecting a pair of VMs from the plurality of VMs, the pair of VMs including a higher power consuming VM for a first workload and a lower power consuming VM for a second workload;
receiving performance data and power consumption data of the higher power consuming VM;
predicting performance data for the lower power consuming VM of the pair of VMs under the first workload;
predicting power consumption data for the lower power consuming VM based on the predicted performance data and using a trained machine learning model;
determining whether the predicted power consumption data for the lower power consuming VM remains lower than the power consumption data of the higher power consuming VM; and
linking in the map of VMs, in response to a positive result of the determining, a candidate migration from the higher power consuming VM to the lower power consuming VM.

4. The method of claim 1, wherein the predetermined criteria correspond to conflicts with redeployment of the software operations to any VM among the plurality of VM.

5. The method of claim 1, wherein the selecting, based on the ranking, one of the identified candidate VMs as the second VM comprises:
simulating the common workload to test the identified VMs in a hierarchical order of the ranking; and
terminating the simulation, in response to a positive result of the test, and selecting the identified VM as the second VM.

6. The method of claim 1, further comprising after the terminating:
monitoring for changes in hardware configurations or power consumption of the second VM;
redeploying the software operations from the second VM to a third VM by returning to the identifying with the second VM as the first VM; and
updating the map of VMs.

7. A system for redeploying software operations from a first virtual machine (VM) to a second VM, the system comprising:
a processor;
a memory storing instructions programmed to cooperate with the processor to perform operations comprising:
identifying, using a map of VMs, a set of candidate VMs that are predicted to consume less power over time than the first VM for a common workload;
removing from consideration any of the candidate VM from the set of candidate VMs that fails to satisfy any predetermined criteria;
performing tradeoff analysis on the remaining candidate VMs based on one or more parameters to identify the candidate VMs for redeploying the software operations;
ranking the identified candidate VMs based on at least predicted power consumption data for the common workload;
selecting, based on the ranking, one of the identified candidate VMs as the second VM;
redeploying the software operations from the first VM to the second VM;
rerouting data inflow to the first VM to the second VM; and
terminating operations of the first VM.

8. The system of claim 7, wherein the map of VMs comprises a list of a plurality of VMs and mappings between the VMs based on predicted power consumption data for the common workload.

9. The system of claim 8, wherein generating, by the processor, the map of VMs comprises:
Selecting, by the processor, a pair of VMs from the plurality of VMs, the pair of VMs including a higher power consuming VM for a first workload and a lower power consuming VM for a second workload;
receiving, by the processor, performance data and power consumption data of the higher power consuming VM;
predicting, by the processor, performance data for the lower power consuming VM of the pair of VMs under the first workload;
predicting, by the processor, power consumption data for the lower power consuming VM based on the predicted performance data and using a trained machine learning model;
determining, by the processor, whether the predicted power consumption data for the lower power consuming VM remains lower than the power consumption data of the higher power consuming VM; and
linking in the map of VMs, by the processor, in response to a positive result of the determining, a candidate migration from the higher power consuming VM to the lower power consuming VM.

10. The system of claim 7, wherein the predetermined criteria correspond to conflicts with redeployment of the software operations to any VM among the plurality of VM.

11. The system of claim 7, wherein the selecting by the processor, based on the ranking, one of the identified candidate VMs as the second VM comprises:
simulating the common workload to test the identified VMs in a hierarchical order of the ranking; and
terminating the simulation, in response to a positive result of the test, and selecting the identified VM as the second VM.

12. The system of claim 7, further comprising after the terminating:
monitoring for changes in hardware configurations or power consumption of the second VM;
redeploying the software operations from the second VM to a third VM by returning to the identifying with the second VM as the first VM; and
updating the map of VMs.

13. A non-transitory computer readable storage media coupled to a processor and having instructions storing thereon which, when executed by the processor, cause the processor to perform operations for redeploying software operations from a first virtual machine (VM) to a second VM, the operations comprising:
identifying, using a map of VMs, a set of candidate VMs that are predicted to consume less power over time than the first VM for a common workload;
removing from consideration any of the candidate VM from the set of candidate VMs that fails to satisfy any predetermined criteria;
performing tradeoff analysis on the remaining candidate VMs based on one or more parameters to identify the candidate VMs for redeploying the software operations;
ranking the identified candidate VMs based on at least predicted power consumption data for the common workload;
selecting, based on the ranking, one of the identified candidate VMs as the second VM;
redeploying the software operations from the first VM to the second VM;
rerouting data inflow to the first VM to the second VM; and
terminating operations of the first VM.

14. The non-transitory computer readable storage media of claim 13, wherein the map of VMs comprises a list of a plurality of VMs and mappings between the VMs based on predicted power consumption data for the common workload.

15. The non-transitory computer readable storage media of claim 14, wherein generating the map of VMs comprising:
selecting a pair of VMs from the plurality of VMs, the pair of VMs including a higher power consuming VM for a first workload and a lower power consuming VM for a second workload;
receiving performance data and power consumption data of the higher power consuming VM;
predicting performance data for the lower power consuming VM of the pair of VMs under the first workload;
predicting power consumption data for the lower power consuming VM based on the predicted performance data and using a trained machine learning model;
determining whether the predicted power consumption data for the lower power consuming VM remains lower than the power consumption data of the higher power consuming VM; and
linking in the map of VMs, in response to a positive result of the determining, a candidate migration from the higher power consuming VM to the lower power consuming VM.

16. The method of claim 1, wherein the predetermined criteria correspond to conflicts with redeployment of the software operations to any VM among the plurality of VM.

17. The non-transitory computer readable storage media of claim 13, wherein the selecting, based on the ranking, one of the identified candidate VMs as the second VM comprises:
simulating the common workload to test the identified VMs in a hierarchical order of the ranking; and
terminating the simulation, in response to a positive result of the test, and selecting the identified VM as the second VM.

18. The non-transitory computer readable storage media of claim 13, further comprising after the terminating:
monitoring for changes in hardware configuration or power consumption of the second VM;
redeploying the software operations from the second VM to a third VM by returning to the identifying with the second VM as the first VM; and
updating the map of VMs.
